(19) United States
(12) Patent Application Publication
(10) Pub. No.: US 2009/0275368 A1
(43) Pub. Date: Nov. 5, 2009

(54) METHOD AND APPARATUS FOR DISTRIBUTING PAGING LOAD IN LONG TERM EVOLUTION

(75) Inventors: Peter S. Wang, East Setauket, NY (US); Shankar Somasundaram, Deer Park, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/432,281

(22) Filed: Apr. 29, 2009

Related U.S. Application Data
(60) Provisional application No. 61/049,487, filed on May 1, 2008.

(51) Int. Cl. H04M 1/00

(52) U.S. Cl. 455/574

(57) ABSTRACT

Methods and apparatus for distributing paging occasion load or multiple Discontinuous Reception (DRX) cycle lengths in Long Term Evolution (LTE) are described. In one method, a phase shifting of a paging frame is applied to distribute the staggering paging load from different frame values to shift a number of frames. A second phase shift method is applied to shift directly the staggering paging frame load to other adjacent frames with an individual frame offset. Another method adds paging sub-frames in the staggering frame to accommodate the overloaded paging load for particular paging occasions.

### CROSS REFERENCE TO RELATED APPLICATIONS

This application claims the benefit of U.S. Provisional Patent Application No. 61/049,487, filed May 1, 2008, which is incorporated by reference as if fully set forth.

### FIELD OF INVENTION

This application is related to wireless communications.

### BACKGROUND

Long Term Evolution (LTE), is a third generation wireless communications technology that provides improved spectral efficiency, reduced latency, better utilization of radio resource to bring faster user experiences and richer applications and services with less cost.

In third generation (3G) networks, paging mechanisms provide efficient use of radio paging resources while maintaining low User Equipment (UE)/Wireless Transmit/Receive Unit (WTRU) power consumption. Paging is used to notify the WTRU for incoming calls and to initiate the network connection establishment and conversation transmissions. In general, for Point-to-Point services, a paging signal that is transmitted to a WTRU is associated with a unique identity assigned to the WTRU. WTRUs generally are in an inactive paging state for considerable time periods while awaiting paging indications. It is desirable to minimize power consumption while the WTRUs are in such a paging state. To accomplish reduced power consumption, paging occasions might be predetermined in the WTRU and network. This predetermination allows the WTRU to minimize the processing between paging occasions, which results in reduced power consumption and correspondingly increased battery life. Hereafter an ON state designates that the WTRU checks at the paging occasions and the OFF state designates that the WTRU is inactive for saving power and is in a Discontinuous Reception (DRX) scheme for paging reception.

The DRX scheme assumes that each WTRU has a unique identity called a UE_ID. This UE_ID might be a International Mobile Subscriber Identity (IMSI) or a S-Temporary Mobile Subscriber Identity (S-TMSI) with a paging cycle length, which is obtained either from the defaultPagingCycle InformationElement (IE), received from a SystemInformationBlock (SIB) 2 or a WTRU specific DRX value determined at the WTRU Non Access Stratum (NAS) level. Using the unique UE-ID and the paging cycle length, it is possible to compute a WTRU specific paging parameter.

These specific paging parameters are generally identified as frame numbers/paging frame numbers (PF) and a sub-frame paging occasion (PO). The network ensures that it delivers paging messages only to those WTRUs at a specific PF/PO whose paging parameters have already been determined. In this way, a WTRU is able to go in an inactive mode, thereby saving power.

Several WTRUs may listen for these paging parameters or signals. These parameters are the specified frame and subframe where the WTRU monitors its paging signal and the paging records in the paging message if the paging signal indicates there is a paging message from the network. Thus, for signal processing, a WTRU's Radio Resource Control (RRC) layer must check whether any of the paging identities of the received paging records matches its identity. If a match is found, the paging indication is forwarded to a mobility management function-which then triggers a call management function for response.

There is a trade-off between mobile standby times and call response times. If the DRX procedure uses a long DRX cycle, (i.e. the E-UTRAN network sends paging messages after long periods or rarely), then WTRUs do not listen to the paging as often and this saves power. This also results in longer WTRU standby times-and accordingly a drawback is the longer call response time (for WTRU terminated calls). These parameters are usually set up by the network operator and they can also be changed via a system information broadcast.

For paging services, the paging parameters are determined from identities unique to each WTRU. A motivation for using WTRU identities is to provide a substantially equal distribution of paging transmissions across all paging resources.

PF, is the frame number on which there may be a Paging-Radio Network Temporary Identifier (P-RNTI) transmitted on a Physical Downlink Control CHannel (PDCCH) addressing the message. One PF may contain one or more PO(s). The WTRU monitors one P-RNTI per DRX cycle, which is usually determined at the WTRU as the lowest of either the paging cycle or the default PagingCycle from SIB-2. Key paging configuration fields are then sent from the network to the WTRU Radio Resource Control (RRC). The RRC then relays this configuration to a L1 layer. These fields are the following: Paging_DRX_T (T); Paging_Group_Count (N); PO_Count_in_a_PF (Ns).
Paging_DRX_T (T) for the length of the DRX cycle in the range of [32, 64, 128 and 256] frames. Therefore, as a frame is 10 ms, in between paging, the period can vary from 320 ms (32*10 ms) to 2.56 s (256*10 ms). This range is more constrained than for UMTS which was 80 ms-5.12 s.
Paging_Group_Count (N) for the number of paging groups within a DRX cycle T on the radio frame level in the range of [2, 4, 8, 16, 32, 64, 128 and 256], where N<T.
PO_Count_in_a_PF (Ns) for the number of Paging Occasions in a PF, values are [1, 2 and 4]. UE_ID: using IMSI mode 4096, where IMSI is given as sequence of digits of type Integer(0 . . . 9), IMSI in the formulae is be interpreted as a decimal integer number, where the first digit given in the sequence represents the highest order digit. For example:

IMSI=12 (digit1=1, digit2=2)

In the calculations, it is interpreted as decimal integer “12”, not “1×16+2=18”, i.e. a binary count is not used. For power conservation, a WTRU finds its cycle for paging by first locating its Paging Frame with the PF formula, and then finding the exact PO within the PF with a PO-formula;

An example equation for determining a paging parameter is the equation of a paging frame, PF derived from the WTRU identity, is given by Equation 1,

SFN mod T=(T/N)*(UE_{—}ID mod N); Equation [1]

wherein SFN is a System Frame Number, T is paging DRX cycle length value, and the N is paging group count value, each are used to determine the paging frames on a radio frame level. However, when staggering is used, a problem of excessive paging load in certain paging frames results.

To see the affect of overloading, for Equation 1, consider as an example, T=32 and N=2, The PF Equation 1 then becomes: SFN mod 32=(32/2)*(UE_ID mod 2).

TABLE 1
Paging Frame Determination
Paging Frame (PF): SFN mod T = (T/N) * (UE_ID mod N)

| Case | T, N | PF | | PO in frames | UE_Id Group |
|---|---|---|---|---|---|
| SFN mod | T = 32 | 16 × [0, 1] | 0 | SFN mod 32 = 0 | Group 1 for UE_Id |
| 32 | N = 2 | | | | mod N = 0 |
| | | | 16 | SFN mod 32 = 16 | Group 2 for UE_Id |
| | | | | | mod N = 1 |
| SFN mod | T = 64 | 16 × [0, 1, 2, 3] | 0 | SFN mod 64 = 0 | Group 1 for UE_Id |
| 64 | N = 4 | | | | mod N = 0 |
| | | | 16 | SFN mod 64 = 16 | Group 2 for UE_Id |
| | | | | | mod N = 1 |
| | | | 32 | SFN mod 64 = 32 | Group 3 for UE_Id |
| | | | | | mod N = 2 |
| | | | 48 | SFN mod 64 = 48 | Group 4 for UE_Id |
| | | | | | mod N = 3 |
| SFN mod | T = 128 | 32 × [0, 1, 2, 3] | 0 | SFN mod 128 = 0 | Group 1 for UE_Id |
| 128 | N = 4 | | | | mod N = 0 |
| | | | 32 | SFN mod 128 = 32 | Group 2 for UE_Id |
| | | | | | mod N = 1 |
| | | | 64 | SFN mod 128 = 64 | Group 3 for UE_Id |
| | | | | | mod N = 2 |
| | | | 96 | SFN mod 128 = 96 | Group 4 for UE_Id |
| | | | | | mod N = 3 |
| SFN mod | T = 256 | 64 × [0, 1, 2, 3] | 0 | SFN mod 256 = 0 | Group 1 for UE_Id |
| 256 | N = 4 | | | | mod N = 0 |
| | | | 64 | SFN mod 256 = 1 | Group 2 for UE_Id |
| | | | | | mod N = 1 |
| | | | 128 | SFN mod 256 = 2 | Group 3 for UE_Id |
| | | | | | mod N = 2 |
| | | | 192 | SFN mod 256 = 3 | Group 4 for UE_Id |
| | | | | | mod N = 3 |

As can be observed from Table 1, changing the value of T (i.e. the DRX Cycle length) to other values in Equation 1, where the term “UE_ID mod N” equates to value 0 regardless of periodicity change, has no affect for an overloaded frame. This is because the value “SFN mod T” equates to zero. That is, for example, SFN mod 32=16×[0, 1] equates to [0, 16] and the WTRUs will have paging parameters that correspond to frames having value SFN mod 32=0 if the UE_ID belongs to group 1 from UE_ID mod N=0; or SFN mod 32=16 if UE_ID belongs to group 2 from UE_ID mod N=1. This case is similar for other values of the paging Frame equal to zero as shown in Table 1.

Therefore, for any T value, radio frame corresponding to the SFN mod T=0 occurs carrying a nominal four fold paging load. This is summarized in Table 1 where the staggered occasions are highlighted and also illustrated in FIG. 1.

Another example equation of paging parameter is the equation of a paging occasion PO in a paging frame, is given by Equation 2,

i_{—}s=(UE_{—}ID/N) mod Ns Equation [2]

where the i_s indexes the positioning of the PO within the PF. However, determining which exact sub-frame number inside a PF is the PO (corresponding to the i_s positioning) depends on the paging frame pattern. An illustration of the sub-frame patterns is given in Table 2 below. An illustration of a PO in a PF is provided in FIG. 2.

TABLE 2
Subframe Patterns in a PF for Paging

| | PO when | PO when | | |
|---|---|---|---|---|
| Ns | i_s = 0 | i_s = 1 | PO when i_s = 2 | PO when i_s = 3 |
| 1 | 4 | N/A | N/A | N/A |
| 2 | 4 | 9 | N/A | N/A |
| 4 | 0 | 4 | 5 | 9 |

Therefore, the overload situation exists due to the modulo N equal to zero part in Equation 1 for the possible multiple paging DRX cycle lengths. This overloaded situation becomes very severe when the system assigned paging group count number N is small and when the particular paging area of LTE cells is suddenly loaded with a large number of WTRUs due to events that result in a large public assembly, or an event of a large public gathering or in general any crowding situation. Hence, it is desirable to provide for ensuring that paging load distribution is uniform.

### SUMMARY

Methods and apparatus for distributing paging load for multiple DRX cycle lengths in LTE are described. In one method, a phase shifting of a paging frame is applied to distribute the staggering paging load from different T values to shift a number of frames. In another method, a phase shift is applied to shift directly the staggering paging frame load to other adjacent frames with an individual frame offset. In another method, paging sub-frames are added in a staggering frame to accommodate the increased mounted paging load.

### BRIEF DESCRIPTION OF THE DRAWINGS

A more detailed understanding may be had from the following description, given by way of example in conjunction with the accompanying drawings wherein:

FIG. 1 shows an example of paging parameters from different DRX cycle lengths that stagger/overload on the same frame;

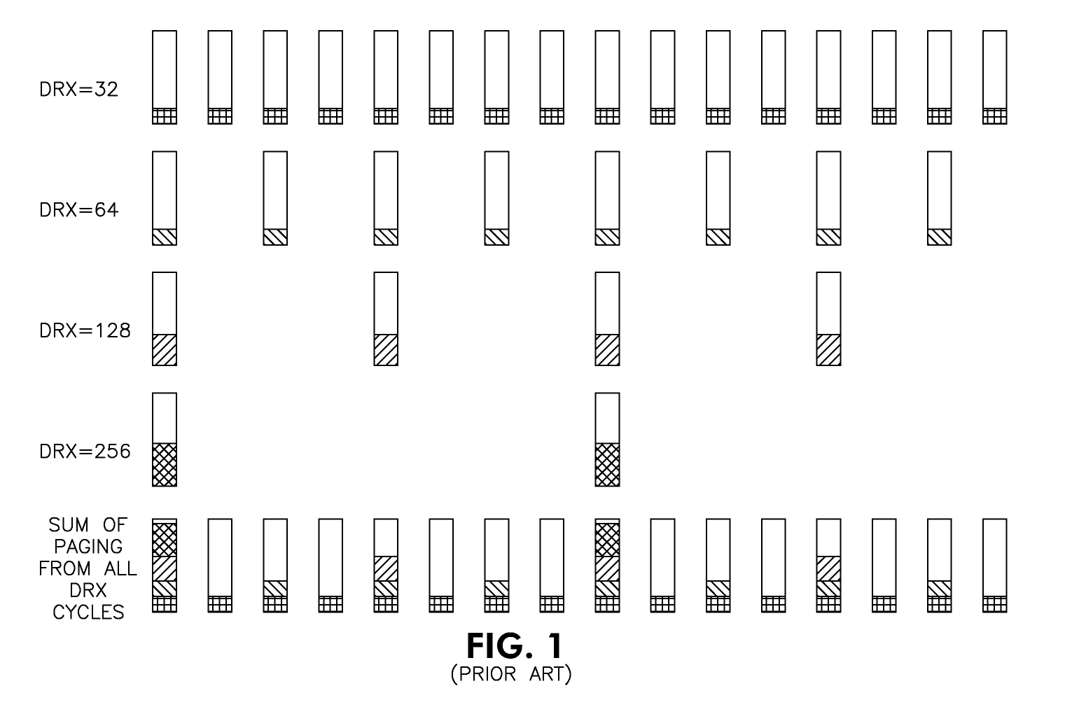

FIG. 2 shows an example illustration of PO (sub-frame) in a PF (frame).

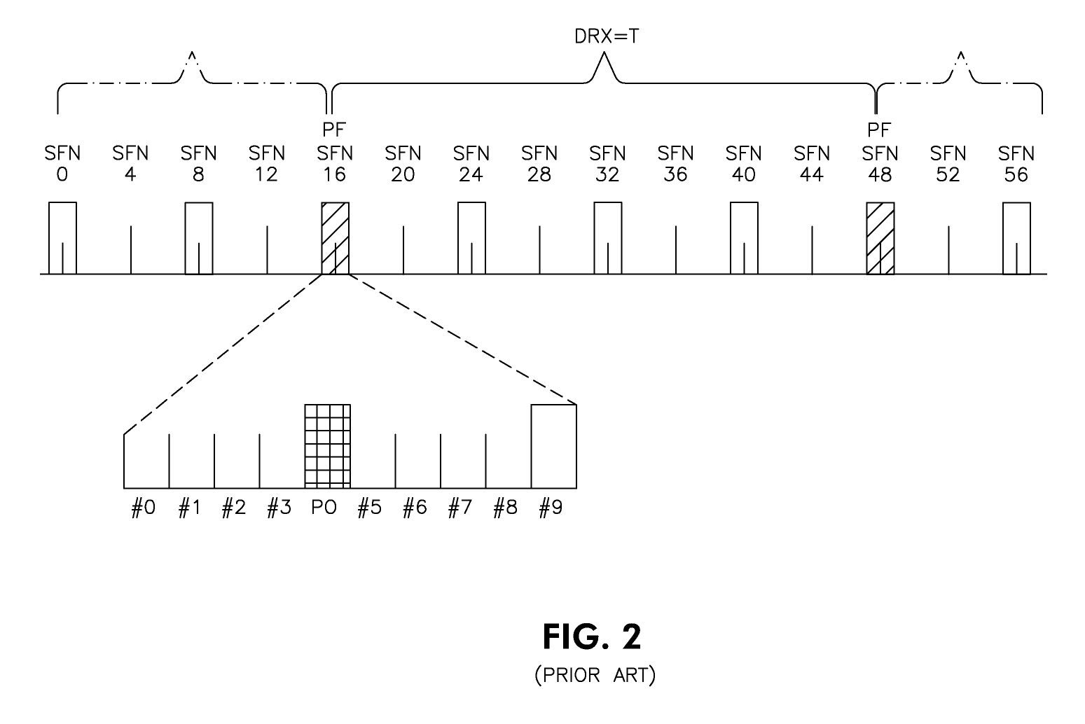

FIG. 3 shows a wireless communication system including a plurality of WTRUs divided into groups and an evolved Node B, eNB;

FIG. 4 is a functional block diagram of the WTRU and an eNB of the wireless communication system of FIG. 3;

FIG. 5 shows an example of a shifted paging frame for stagerred/overloaded cases; and

FIG. 6 shows an example of provisioning of additional sub-frame patterns in a PF.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

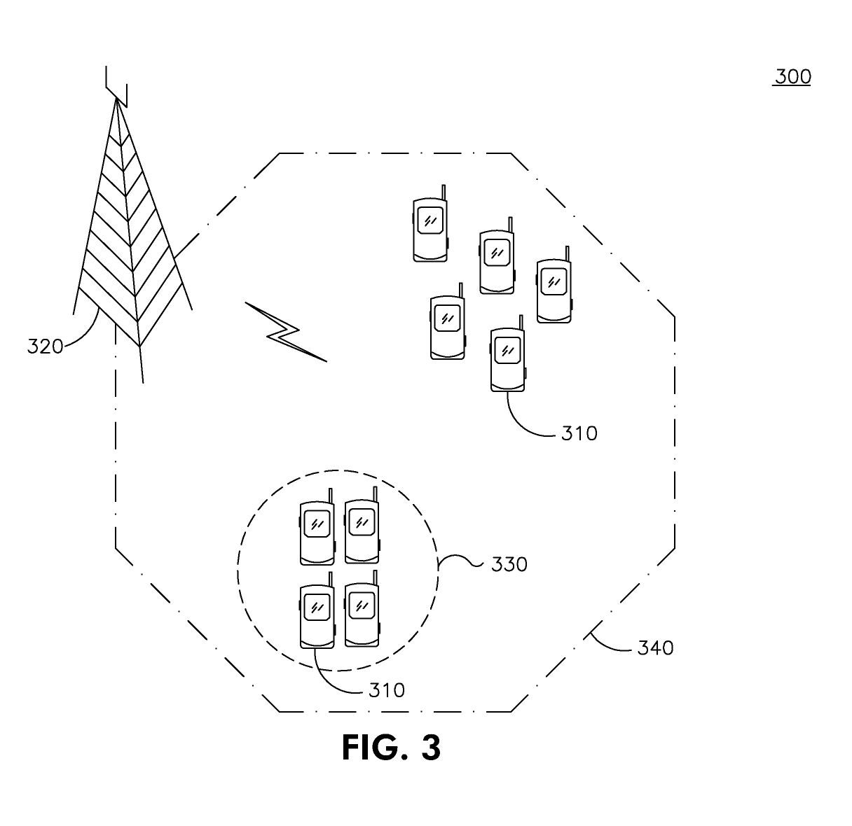

FIG. 3 is a an exemplary diagram of WTRUs 310 and an eNB 320 of a wireless communication system 300. As shown in FIG. 3, the WTRUs 310 are in communication with the eNB 320 which is part of a communications network. One small group of WTRUs 330 are in a situation where overloading occurs i.e. 330 is a designation for a set of WTRUs in a cell 340 that is overloaded with a large number of WTRUs due to events that result in a large public assembly, or an event of a large public gathering or in general any crowding situation. The WTRU 310 is configured to transmit feedback signals and control signals to the eNB 320. The WTRU is also configured to receive and transmit feedback and control signals from and to the eNB. Both the eNB and the WTRU are configured to process signals that are modulated and coded.

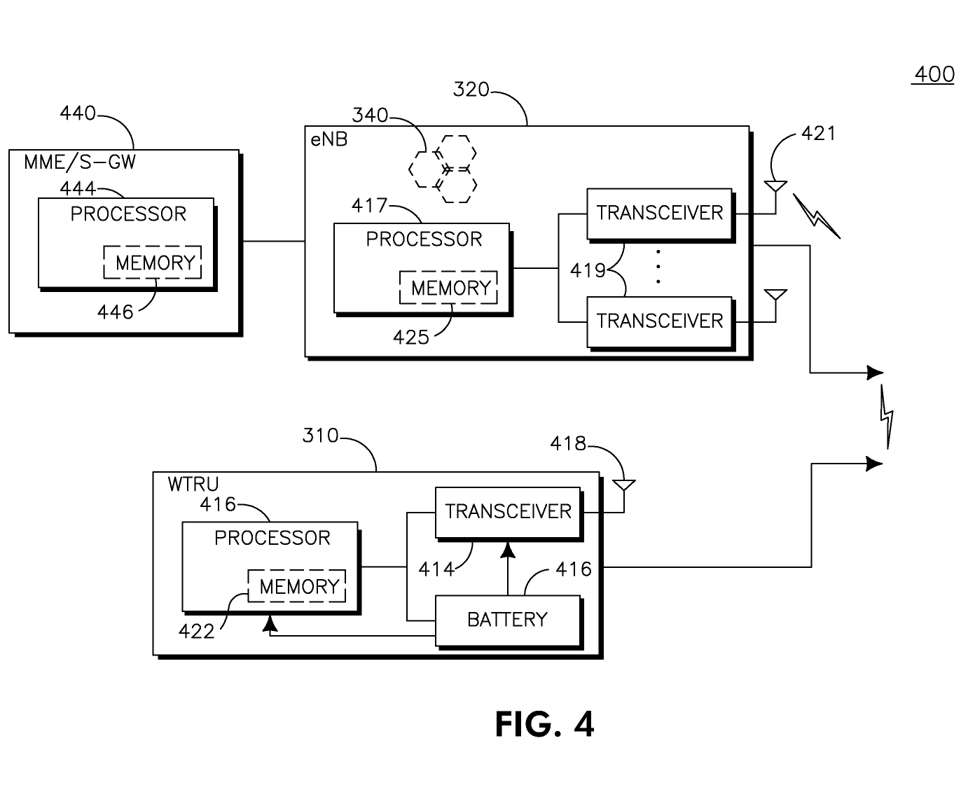

FIG. 4 shows a wireless communication system 400 including a WTRU 310 and an evolved Node B, eNB 320. Although a single WTRU 310 and a single eNB 320 are shown in FIG. 4, it should be apparent that any combination of wireless and wired devices may be included in the wireless communication system 400.

As shown in FIG. 4, the WTRU 310 is in communication with the eNB 320. In addition to the components that may be found in a typical WTRU, the WTRU 310 includes a processor 416 with a linked memory 422, a transmitter and receiver together designated as transceiver 414, a battery 416, and an antenna 418. The transceiver 414 is in communication with the processor 416 to facilitate the transmission and reception of wireless communications.

In addition to the components that may be found in a typical eNB in cell 340, the eNB 320 includes a processor 417 with a linked memory 425, transceivers 419, and antennas 421. The transceivers 419 are in communication with the processor 417 to facilitate the transmission and reception of wireless communications. The eNB 320 is part of the network and is connected to the Mobility Management Entity/Serving GateWay (MME/S-GW) 440 having a processor 444 with a linked memory 446.

The following methods may be used independently or used together in combination to ensure that the paging load distribution occurs without overloading. One method describes phase shifting the paging frame cycle by the DRX cycle length, and the other describes defining more paging sub-frames in the staggering frames.

Shifting the paging frame cycle is done either by shifting with the shortest DRX cycle or shifting with individual frames.

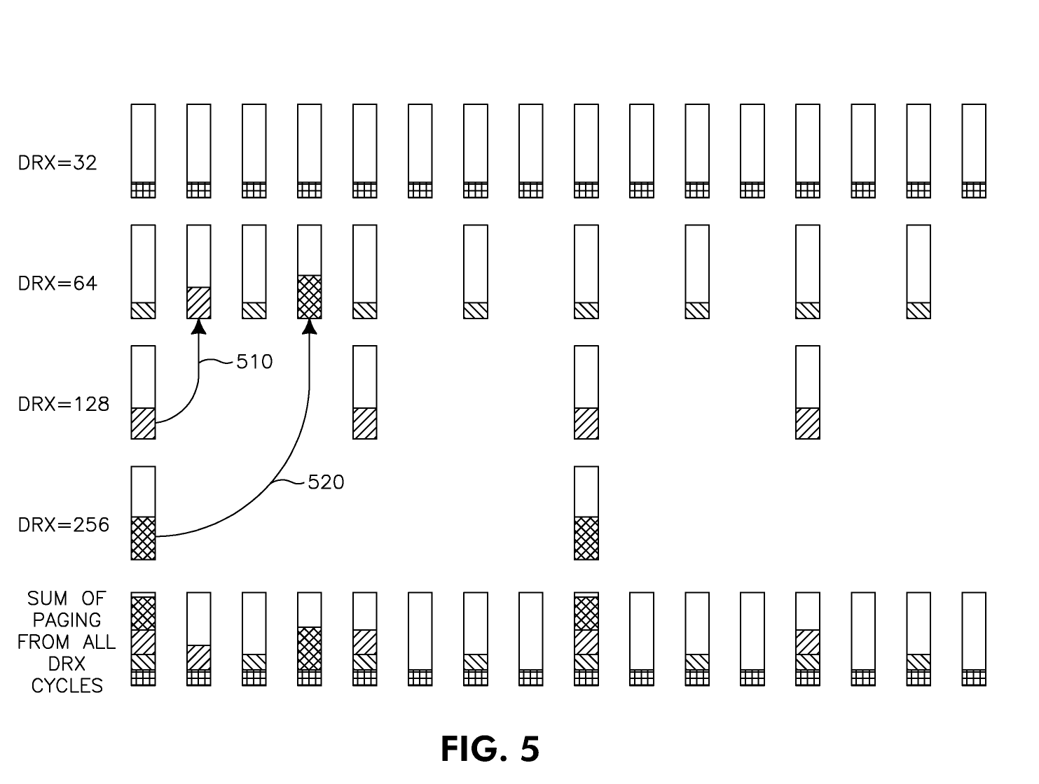

Shift with the Shortest DRX Cycle

Where overloading occurs, consider as an example the staggering load on DRX=256 occasions as shown in FIG. 5. This overloaded paging frame cycle is phase shifted and the shifting is based upon T=DRX cycle values, especially the longer DRX cycle lengths, such as T=128 and T=256. In FIG. 5, these longer cycle lengths DRX=128, 510 and the DRX=256, 520 are arranged so as to not overlap with the frame cycle of DRX=64. As can be seen in FIG. 5, these cycle lengths do not overlap for value SFN mod T=0 because they have been shifted.

The base shift is designated as a multiple on the lowest DRX value, that is the DRX=32 with different factors of multiple frames on the T value (i.e. the DRX cycle length value) as shown in FIG. 5. A formula is provided for the above described PF cycle shift as depicted in FIG. 5, where the shift is indicated by a floor function in Equation 3 given below:

SFN mod T=[(T/N)*(UE_{—}ID mod N)+└T/65┘*32], Equation [3]

where └ ┘ is a floor function and T is given as one of the DRX cycle lengths 32, 64, 128, 256; and the factor 32 (i.e., the last term in Equation 3) is based on the lowest T value served as the number of LTE frames as the base unit of shift. The factor 65 is chosen so that T=64 resulted in no shift, T=128 resulted in a one unit shift and T=256 resulted in a shift of 3 base units-that is 96 frames.

A more generalized Equation 3 for paging frame determination to avoid overloading is written as Equation 4,

SFN mod T=[(T/N)*(UE_{—}ID mod N)+└T/Tx┘*Fs]; Equation [4]

where Tx is signaled to the WTRU as the dividor to determine the number of units of the shift, while the Fs is the number of frames signaled to WTRU as the base unit for shifting, determined by the network. One example is Fs=T/N.

By giving different values of Tx and Fs, different phase shifts with respect to the paging DRX cycle T can be achieved for dsitributing the paging load at SFN mod T=0 and thus the overloading problem is avoided entirely.

TABLE 3
Modified Paging Prame
PF = SFN mod T = [(T/N) * (UE_ID mod N) + (floor (T/Tx)) * Fs]

| | | Floor | | |
|---|---|---|---|---|
| Case | T, N | (T/Tx) | Fs | PF |
| SFN mod | T = 64, | 0 | 16 | No shift |
| 64 | 128, 256 | 1 | | (Shift by) 1 base unit = 16 frames |
| | N = 4 | 3 | | (Shift by) 3 base units = 48 frames |
| | Tx = 65 | | | |
| | T = 64, | 0 (64) | | No shift |
| | 128, 256 | 1 (128) | | (Shift by) 1 base unit = 32 frames |
| | N = 2 | 3 (256) | | (Shift by) 3 base units = 96 frames |
| | Tx = 65 | | | |
| | | 1 | | (Shift by) 1 base unit = 16 frames |
| | T = 64, | 3 | | (Shift by) 2 base units = 48 frames |
| | 128, 192, | | | |
| | 256 | | | |
| | N = 2 | 5 | | (Shift by) 3 base units = 80 frames |
| | Tx = 33 | 7 | | (Shift by) 4 base units = 102 |
| | | | | frames |

In Table 3, three possible cases for determining PF are summarized.

Shift with Individual Frames

Alternatively, the paging frame phase shift may be individual frames starting from the staggering paging frames (when SFN mod T=0) usually resulting adjacent frame(s) according to the T value as seen in Equation 5.

SFN mod T=[(T/N)*(UE_{—}ID mod N)]+(T/Ts+OFFSET); Equation [5]

where Ts is by default the shortest DRX cycle length (i.e. Ts=32). Alternately, Ts can also be signaled to the WTRU as the divisor to determine the number of frames of the shift. The OFFSET value in the shift term in Equation 5 is designated for adjusting the frames shifted. It could have negative, zero, or positive values in the range of [−Ts+1, . . . , −1, 0, 1, 2, . . . , Ts−1]. For example if T=32 and Ts=32, OFFSET=−1, then the shift term (T/Ts+OFFSET) results in no shift, but for T=64, 128, and 256, it results in a shift of 1 frame, 2 frames, and 3 frames, respectively. This offset starting from the overloaded frame is summarized in Table 4.

TABLE 4
Example: Individually shifted paging frame
PF = SFN mod T = [(T/N) * UE_ID mod N) + (T/Ts +/− OFFSET)

| Case | T, N | T/Ts +− OFFSET | | PF |
|---|---|---|---|---|
| SFN mod 32 | T = 32, 64, | 32/32 − 1 | 0 | No shift |
| | 128, 256 | 64/32 − 1 | 1 | 1 frame |
| | Ts = 32 | 128/32 − 1 | 3 | 3 frames |
| | | 256/32 − 1 | 7 | 7 frames |

Defining More Subframes

Another method for distributing the paging load in a overloading scenario is defining more paging sub-frames, Ns0, in the staggering frames i.e. a greater number of sub-frames are specified in the overloading case. With this method, the PF is defined the same as in Equation 1. However, for the frames being staggered/overloaded that correspond to SFN mod Tx=0, where Tx includes all T values, e.g. 32, 64, 128, 256, a definition for more paging occasions PO is made within a frame. This value Ns0 accommodates the possible staggering load on the PF, and optionally the next frame if the first frame does not have the bandwidth for the paging load. The value Ns0 is defined by one of the following Equations 6 or 7.

Ns0=└T/Ds┘*Ns; Equation [6] or,

Ns0=└T/Ds┘*Ns. Equation [7]

where T is the paging DRX cycle length for individual WTRUs and Ds is a network or standard determined value. In case that the value └T/Ds┘ is greater than 1, additional subframes are added to the PF (at SFN mod T=0) to handle the additional paging load.

For the exact sub-frame PO, index i_s pointing to PO from the PF pattern is derived by the following Equation 8.

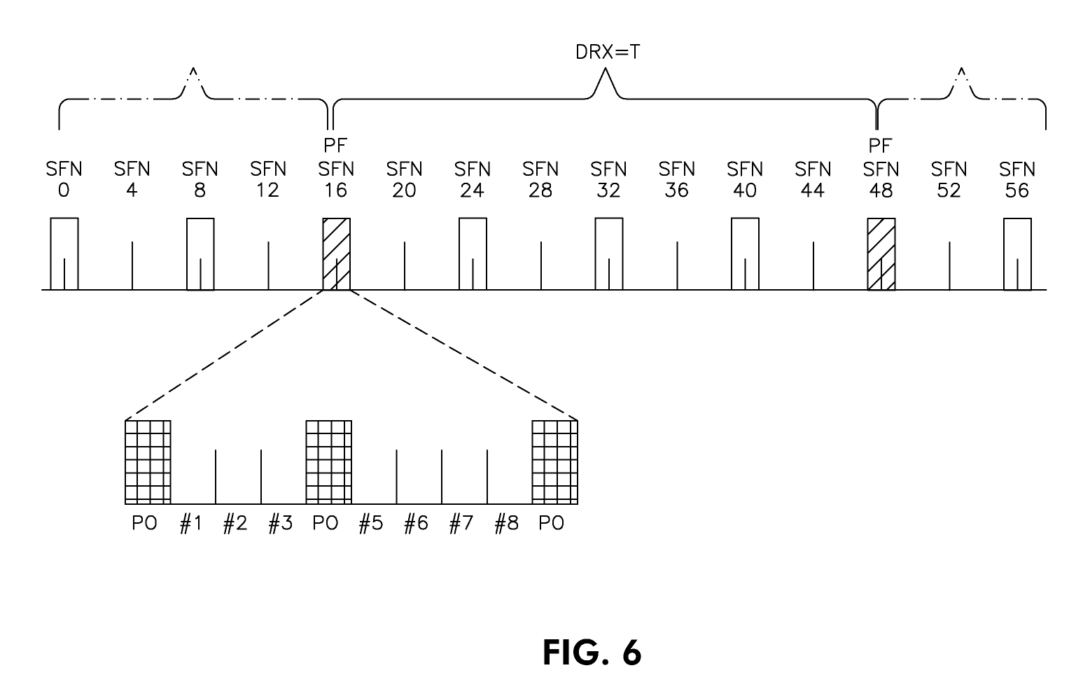

i_{—}s=(UE_{—}ID mod(Ns0−Ns)). Equation [8]

wherein WTRUs compute the Ns0, and compare the resulted Ns0 against the Ns. If the resulted Ns0 has the same value as Ns, then the existing i_s=(UE_ID/N) mod Ns is used to locate the PO within the PF. If Ns0 is greater than Ns, then Equation 8 is used where Ns0 is obtained from Equation 6. An example illustration of provisioning of additional POs in a PF is shown in FIG. 6. In case Ns0 is obtained from Equation 7, the PO sub-frames for the particular T may be in the next adjacent frame, where the i_s=(UE_ID/N) mod Ns.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or the Evolved Packet Core (EPC), radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A wireless transmit/receive unit (WTRU) configured to reduce power consumption from a battery, the WTRU comprising:
a transceiver configured to receive paging signals; and
a processor configured to:
determine paging parameters, including a Paging Frame (PF) and a Paging Occasion (PO) based upon an identification parameter; and
monitor and synchronize to a discontinuous reception (DRX) cycle based upon paging parameters.

2. The WTRU of claim 1, wherein the identification parameter is International Mobile Subscriber Identity (IMSI) or a S-Temporary Mobile Subscriber Identity (S-TMSI) and a paging cycle length.

3. The WTRU of claim 2, wherein the paging cycle length is signaled to the WTRU.

4. The WTRU of claim 1, wherein in response to a determination for a paging parameter resulting in a overloading case, the PF determined is shifted by a phase equal to a DRX cycle length or a shorter value of the DRX cycle length.

5. The WTRU of claim 4, wherein for an overloaded or staggering load case, PF is obtained when SFN mod T=0, where SFN is a Sequence Frame Number and T is paging DRX cycle length value.

6. The WTRU of claim 4, wherein the overloaded PF is phase shifted on a DRX cycle resulting in DRX values arranged in a non-overlapping manner.

7. The WTRU of claim 6, wherein for phase shifting the PF, a base shift is designated as a multiple on a lowest DRX value, with different factors of multiple frames on the T value.

8. The WTRU of claim 4, wherein the shifted PF is determined by the relation:
SFN mod T=[(T/N)*(UE_{—}ID mod N)+└T/Tx┘*Fs]
where └ ┘ is a floor function, T is one of the DRX cycle lengths, Tx is signaled to the WTRU as a divisor to determine the number of shift units, Fs is the number of frames signaled to WTRU as a base unit of shifting, N is paging group count value
such that by having different values of Tx and Fs, different phase shifts with respect to the paging DRX cycle T are achieved for dsitributing the overloaded paging load.

9. The WTRU of claim 8, wherein Fs is determined by a network and signaled to WTRU.

10. The WTRU of claim 8, wherein Fs=T/N

11. The WTRU of claim 1, wherein in response to a determination for a paging parameter resulting in a overloading case, the PF determined is shifted by a phase shift with individual frames starting from overloaded frame.

12. The WTRU of claim 11, wherein the shifted PF is determined as:
SFN mod T=[(T/N)*(UE_{—}ID mod N)]+(T/Ts+OFFSET);
where T is given as one of DRX cycle lengths, N is paging group count value, Ts is by default a shorter DRX cycle length, the OFFSET value in the shift term is designated for adjusting the frames shifted and has negative, zero or positive values, in the range of [−Tₛ+1, . . . , −1, 0, 1, 2, . . . , Tₛ−1].

13. The WTRU of claim 1, wherein in response to the determination for a paging parameter resulting in overloading, a greater number of sub-frames corresponding to PO, designated by Ns0, are defined for an additional paging load.

14. The WTRU of claim 13, wherein the number of PO is made within a paging frame PF and the value Ns0 accommodates the staggered/additional load on the PF.

15. The WTRU of claim 13, wherein the number of PO is made within a next frame in case a first frame does not have the bandwidth of the paging load.

16. The WTRU of claim 13, wherein Ns0 is defined as:
Ns0=└T/Ds┘±Ns; or,
Ns0=└T/Ds┘*NS.
where └ ┘ is a floor function, T is the Paging DRX cycle length for an individual WTRU, Ds is a network or standard determined value, such that for certain large T values, in response to the value └T/Ds┘>1, additional subframes are added to the PF for the overloaded case to handle the additional paging load and Ns specifies values for which there is no overloading.

17. The WTRU of claim 13, wherein the precise PO is determined by an index i_s pointing to the precise PO from subframe pattern, where i_s is:
i_{—}s=(UE_{—}ID mod (Ns0−Ns))

18. The WTRU of claim 17, wherein WTRUs compute additional sub-frames Ns0, and compare the resulting Ns0 against Ns.

19. The WTRU of claim 18, wherein in response to: Ns0=Ns, then i_s=(UE_ID/N) mod Ns provides the precise PO; and
Ns0>Ns, then i_s=(UE_ID mod (Ns0−Ns)) where
Ns0=└T/Ds┘±Ns.

20. The WTRU of claim 18, wherein in response to Ns0>Ns, then i_s=(UE_ID mod (Ns0−Ns)) where Ns0=└T/Ds┘*Ns; and the precise PO for a particular T is in the next adjacent frame for which frame, i_s=(UE_ID/N) mod Ns.
